(19) United States
(12) Patent Application Publication
(10) Pub. No.: US 2007/0159714 A1
(43) Pub. Date: Jul. 12, 2007

(54) Storage apparatus with protection function and protection system of storage apparatus

(76) Inventors: Chih-Yuan Kao, Taipei (TW); Chih-Ta Weng, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/642,517

(22) Filed: Dec. 21, 2006

(30) Foreign Application Priority Data
Dec. 28, 2005 (TW) 094222806

(51) Int. Cl. G11B 21/02

(52) U.S. Cl. 360/75

(57) ABSTRACT

A storage apparatus having protection function and a protection system of the storage apparatus are disclosed. The storage apparatus having protection function comprises a storage apparatus main body, a read/write component, an acceleration sensor and a controller. The read/write component can perform data read/write action to the storage apparatus main body. A move acceleration of the storage apparatus can be sensed by the acceleration sensor to generate a sensing result. The read/write component is controlled by the controller to return to an initial position, so as to protect the storage apparatus.

### FIELD OF THE INVENTION

The present invention relates to a storage apparatus with protection function and a protection system of a storage apparatus, and more particularly to the storage apparatus and the protection system to sense a move acceleration of the storage apparatus as the basis for protection.

### BACKGROUND OF THE INVENTION

A storage apparatus for storing data, for instance, a hard drive is a product made by high-technology, including semiconductors, laser optics, precision machines, physics/chemicals, etc. The hard drive includes a read/write head and a plastic made by coating magnetic materials or a metal substrate. While accessing data from the storage apparatus, the read/write head would move back and forth on a surface of the substrate with high-speed rotation to change positive and negative polarities of a magnetic core of the substrate so as to read/write data. Moreover, if there are lots of the magnetic cores on the substrate, the storage capacity of the storage apparatus is bigger. Therefore, the magnetic core is usually made extremely small and high density. Because the read/write head needs to move back and forth on the surface of the substrate with high-speed rotation to read/write data, the read/write head also needs to float on the surface of the substrate to avoid scraping the substrate. However, if a height between the read/write head and the substrate is too big, a data signal may be too weak to influence read/write quality. The height between the read/write head and the substrate is usually reduced. Generally, the height is about 0.5 micron (μm). Because the height between the read/write head and the substrate is really small, when the hard drive reads/writes data, the substrate may rub against the read/write head to cause damages in bad tracks and the read/write head if there are shakes generated by forces.

Therefore, the inventor of the present invention based on years of experience on related research and development invents a storage apparatus with protection function and a protection system of a storage apparatus to overcome the foregoing shortcomings.

### SUMMARY OF THE INVENTION

Briefly, a primary object of the present invention is to provide a storage apparatus with protection function and a protection system of the storage apparatus. Specifically, a move acceleration of the storage apparatus is sensed as the basis for protection, so that when the storage apparatus reads/writes data, the storage apparatus may not be damaged by shakes from external forces.

In accordance with the object of the present invention, the storage apparatus with protection function includes a storage apparatus main body, a read/write component, an acceleration sensor and a controller. The storage apparatus main body includes at least one magnetic disk. A magnetic core of the magnetic disk is used to store data. The read/write component could change positive and negative polarities of the magnetic core of the magnetic disk to perform data read/write action to the storage apparatus main body. When the read/write component performs data read/write action, the acceleration sensor could sense a move acceleration of the storage apparatus with protection function so as to generate a sensing result. The controller compares the sensing result with a predetermined standard value. If the sensing result is greater than the predetermined standard value, the read/write component is controlled to return to an initial position. The initial position is for fixing or disposing the read/write component, so that the storage apparatus can be prevented from being damaged if the read/write component rubs against the magnetic disk.

Moreover, a second object of the present invention is to provide a protection system of a storage apparatus. The system includes an acceleration sensor and a controller. The storage apparatus includes a storage apparatus main body and a read/write component. The storage apparatus is disposed in an electronic apparatus or electrically connected to the electronic apparatus. The acceleration sensor is connected to the storage apparatus. The controller is electrically connected to the acceleration sensor and the storage apparatus. The storage apparatus main body includes at least one magnetic disk. A magnetic core of the magnetic disk is used to store data. When the electronic apparatus accesses data from the storage apparatus, the read/write component then changes positive and negative polarities of the magnetic core of the magnetic disk. The read/write component then performs data read/write action to the storage apparatus main body so as to let the electronic apparatus access data. Meanwhile, the acceleration sensor could sense a move acceleration of the storage apparatus to generate a sensing result. The controller compares the sensing result with a predetermined standard value. If the sensing result is greater than the predetermined standard value, the read/write component is then controlled to return to an initial position. The initial position is for fixing or disposing the read/write component, so that the storage apparatus can be prevented from being damaged if the read/write component rubs against the magnetic disk. Other features and advantages of the present invention and variations thereof will become apparent from the following description, drawings, and claims.

### BRIEF DESCRIPTION OF THE DRAWINGS

FIG. 1 is a block diagram illustrating a storage apparatus with protection function according to an embodiment of the present invention;

FIG. 2 is a schematic diagram illustrating a storage apparatus with protection function according to an embodiment of the present invention; and

FIG. 3 is a schematic diagram illustrating an external hard drive according to an embodiment of the present invention;

FIG. 4 is a block diagram illustrating a protection system of a storage apparatus according to an embodiment of the present invention;

FIG. 5 is a schematic diagram illustrating a storage apparatus according to an embodiment of the present invention; and

FIG. 6 is a block diagram illustrating a protection system of a hard drive according to an embodiment of the present invention.

### DETAILED DESCRIPTION OF THE PREFERRED EMBODIMENTS

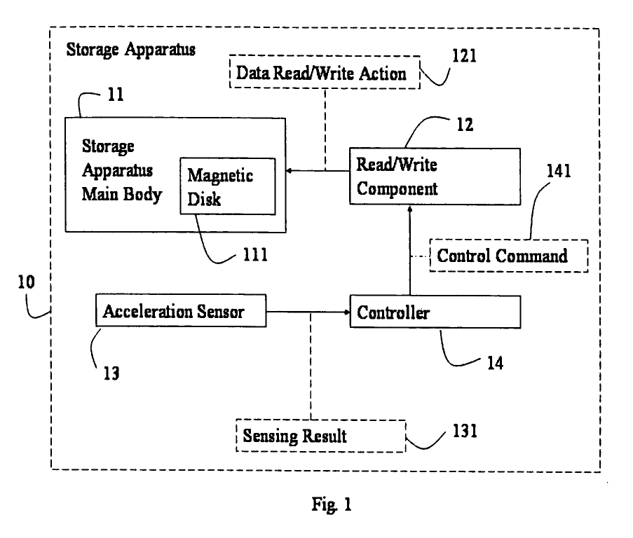

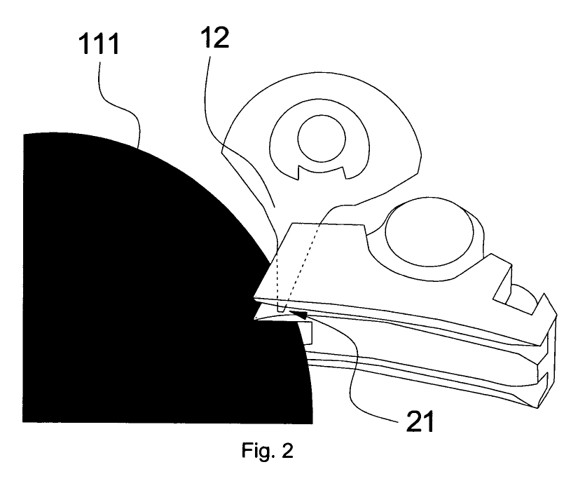

Referring to FIG. 1 and FIG. 2, FIG. 1 is a block diagram illustrating a storage apparatus with protection function according to an embodiment of the present invention. FIG. 2 is a schematic diagram illustrating the storage apparatus with protection function according to an embodiment of the present invention. The storage apparatus is electrically connected to an electronic apparatus or is disposed in the electronic apparatus. The electronic apparatus could access data. The storage apparatus 10 includes a storage apparatus main body 11, a read/write component 12, an acceleration sensor 13 and a controller 14. The storage apparatus main body 11 includes a magnetic disk 111. A magnetic core of the magnetic disk 111 is used to store data. When the electronic apparatus accesses data from the storage apparatus 10, the magnetic disk 111 could high-speed rotate to let the read/write component 12 perform data read/write action 121. The read/write component 12 floats on a surface of the magnetic disk with high-speed rotation. The read/write component 12 could move back and forth. Positive and negative polarities of the magnetic core of the magnetic disk 11 could be changed. The read/write component 12 could perform data read/write action 121 for the storage apparatus main body 11 to sense a move acceleration of the storage apparatus 10. A sensing result 131 is then generated. The controller 14 compares the sensing result 131 with a predetermined standard value in the controller 14. When the sensing result 131 is greater than the predetermined standard value, the controller 14 sends a control command 141 to the read/write component 12. The read/write component 12 is then controlled to return to an initial position 21 as shown in FIG. 2. The initial position 21 is for fixing or placing the read/write component 12. The storage apparatus 10 is a hard drive or an external hard drive. The acceleration sensor 13 is an acceleration sensor chip.

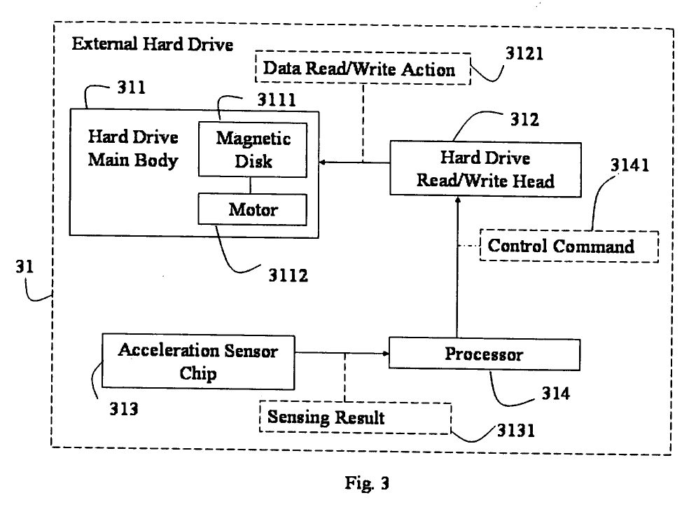

Referring to FIG. 3, a block diagram illustrates an external hard drive according to an embodiment of the present invention. The external hard drive is electrically connected to the electronic apparatus to let the electronic apparatus access data. The external hard drive 31 includes a hard drive main body 311, a hard drive read/write head, 312, an acceleration sensor chip 313 and a processor 314. The hard drive main body 311 includes a magnetic disk 3111 and a motor 3112. The motor 3112 is connected to the magnetic disk 3111 so as to provide 7, 200 revolutions per minutes (RPM). A magnetic core of the magnetic disk 3111 is used to store data. The magnetic disk 3111 could perform 7, 200 RPM through the motor 3112. When the electronic apparatus accesses data from the external hard drive 31, the hard drive read/write head 312 keeps a 0.5 micron height to float back and forth onto a surface of the magnetic disk 3111 with high-speed rotation in order to change positive and negative polarities of the magnetic core of the magnetic disk 3111. The hard drive read/write head 312 then performs data read/write action 3121 to the hard drive main body 311. When the hard drive read/write head 312 performs data read/write action 3121, the acceleration sensor chip 313 senses a move acceleration of the external hard drive 31 through an integrated circuit. A sensing result 3131 is then generated. The processor 314 compares the sensing result 3131 with a predetermined 2 m/s² in the processor 314. The sensing result 3131 is that when the external hard drive 31 moves downward with 9.8 m/s², because 9.8 m/s² is greater than 2 m/s², the processor 314 then sends a control command 3141 to the hard drive read/write head 312. The hard drive read/write head is then controlled to return to an initial position. Therefore, the situation can be avoided to prevent damages to the magnetic disk 3111 or the hard drive read/write head when the external hard drive 31 carelessly falls.

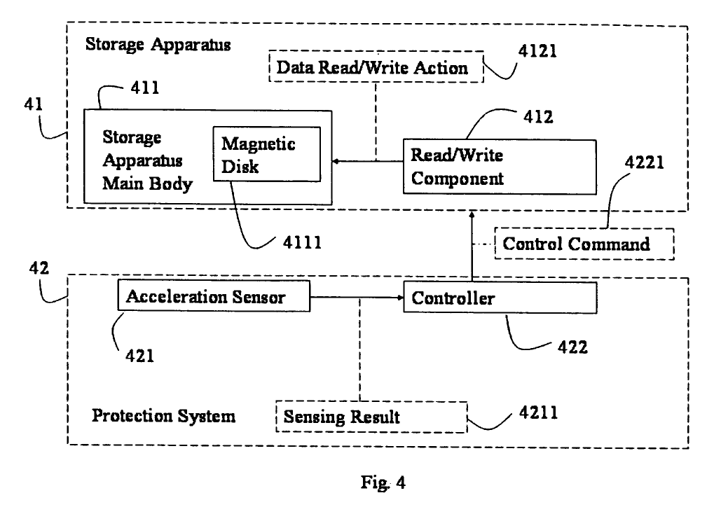

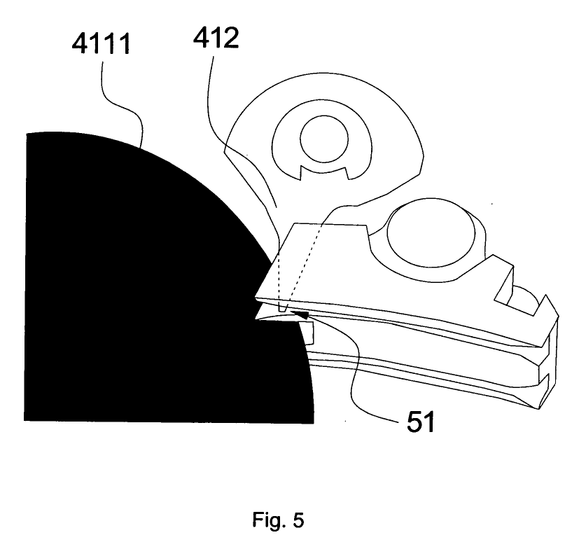

Referring to FIG. 4 and FIG. 5, FIG. 4 is a block diagram illustrating a protection system of a storage apparatus according to an embodiment of the present invention. FIG. 5 is a schematic diagram illustrating the protection system of the storage apparatus according to an embodiment of the present invention. The storage apparatus is electrically connected to the electronic apparatus or is disposed in the electronic apparatus to let the electronic apparatus access data. The protection system 42 includes an acceleration sensor 421 and a controller 422. The storage apparatus 41 includes a storage apparatus main body 411 and a read/write component 412. The acceleration sensor 421 is connected to the storage apparatus 41. The controller 422 is electrically connected to the acceleration sensor 421 and the storage apparatus 41. The storage apparatus main body 411 includes a magnetic disk 4111. A magnetic core of the magnetic disk 4111 is then used to store data. When the electronic apparatus accesses data from the storage apparatus 41, the magnetic disk 4111 could high-speed rotate to let the read/write component 413 perform data read/write action 4121. The read/write component 412 floats on a surface of the magnetic disk 4111, and moves back and forth. Positive and negative polarities of the magnetic core of the magnetic disk 4111 is then changed to perform data read/write action 4121 for the storage apparatus main body 411. When the read/write component 412 performs data read/write action 4121 for the storage apparatus main body 411, the acceleration sensor 421 could sense a move acceleration of the storage apparatus 41 to generate a sensing result 4211. The controller 422 compares the sensing result 4211 with a predetermined standard value in the controller 422. When the sensing result 4211 is greater than the predetermined standard value, the controller 422 then sends a control command 4221 to the read/write component 412. The read/write component 412 is then controlled to return to an initial position 51 as shown in FIG. 5. The initial position 51 is for fixing or placing the read/write component 412. The electronic apparatus is a portable computer. The storage apparatus 41 is a hard drive or an external hard drive. The acceleration sensor 421 is an acceleration sensor chip.

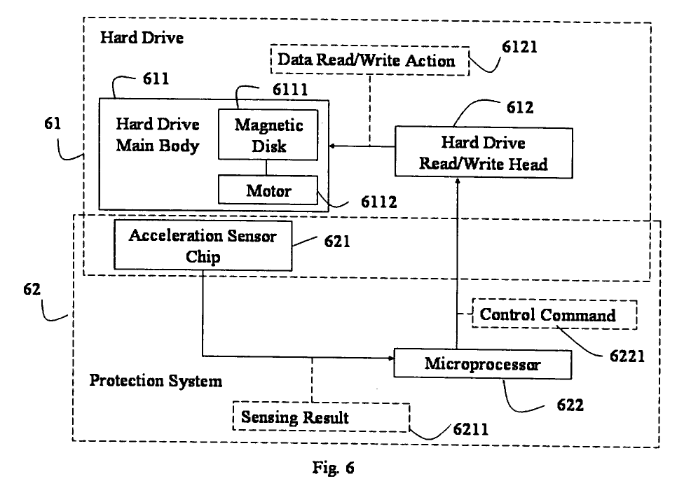

Referring to FIG. 6, a block diagram illustrates a protection system of a hard drive according to an embodiment of the present invention. The protection system could be disposed in a portable computer to let the portable computer access data. The protection system 62 includes an acceleration sensor chip 621 and a microprocessor 622. The hard drive 61 includes a hard drive main body 611 and a hard drive read/write head 612. The acceleration sensor chip 621 is connected to the hard drive 61 or is disposed in the hard drive 61. The microprocessor 622 is electrically connected to the acceleration chip 621 and the hard drive 61. The hard drive main body 611 includes a magnetic disk 6111 and a motor 6112. The motor 6112 is connected to the magnetic disk 6111 so as to provide 7, 200 revolutions per minutes (RPM). A magnetic core of the magnetic disk 6111 is for storing data. The magnetic disk 6111 could perform 7, 200 RPM through the motor 6112. When the portable computer accesses data from the hard drive 61, the hard drive read/write head 612 keeps a 0.5 micron height to float back and forth onto a surface of the magnetic disk 6111 with high-speed rotation in order to change positive and negative polarities of the magnetic core of the magnetic disk 6111. The hard drive read/write head 612 then performs data read/write action 6121 to the hard drive main body 611. When the hard drive read/write head 612 performs data read/write action 6121 to the hard drive main body 611, the acceleration sensor chip 621 senses a move acceleration of the hard drive 61 through an integrated circuit to generate a sensing result 6211. The microprocessor 622 then compares the sensing result 6211 with a predetermined 2 m/s² in the microprocessor 622. The sensing result 6211 is that when the hard drive 61 moves downward with 9.8 m/s², because 9.8 m/s² is greater than 2 m/s², the microprocessor 622 then sends a control command 6221 to the hard drive read/write head 612. The hard drive read/write head 612 is then controlled to return to an initial position. By the way mentioned above, the situation can be avoided to prevent damages to the magnetic disk 6111 or the hard drive read/write head 612 when the portable computer carelessly falls.

Although the features and advantages of the embodiments according to the preferred invention are disclosed, it is not limited to the embodiments described above, but encompasses any and all modifications and changes within the spirit and scope of the following claims.

What is claimed is:

1. A storage apparatus with protection function, comprising:
a storage apparatus main body;
a read/write component for performing data read/write action to said storage apparatus main body;
an acceleration sensor for sensing a move acceleration of said storage apparatus to generate a sensing result; and
a controller for controlling said read/write component to return to an initial position based on said sensing result.

2. The storage apparatus with protection function of claim 1, wherein said storage apparatus with protection function is a hard drive.

3. The storage apparatus with protection function of claim 1, wherein said storage apparatus main body includes at least one magnetic disk, and a magnetic core of said magnetic disk is used to store data.

4. The storage apparatus with protection function of claim 3, wherein said read/write component performing data read/write action is to change positive and negative polarities of said magnetic core of said magnetic disk.

5. The storage apparatus with protection function of claim 1, wherein said read/write component is at least one hard drive read/write head.

6. The storage apparatus with protection function of claim 1, wherein said controller compares said sensing result with a standard value in order to control said read/write component.

7. The storage apparatus with protection function of claim 1, wherein said initial position is for fixing said read/write component.

8. A protection system for a storage apparatus, comprising:
an acceleration sensor for sensing a move acceleration of said storage apparatus to generate a sensing result; and
a controller for controlling said read/write component of said storage apparatus to return to an initial position based on said sensing result.

9. The protection system of claim 8, wherein said storage apparatus is a hard drive.

10. The protection system of claim 8, wherein said acceleration sensor compares said sensing result with a standard value in order to control said read/write component.

11. The protection system of claim 8, wherein said initial position is for fixing said read/write component.

12. The protection system of claim 8, wherein said controller includes a microprocessor and a control program.

13. The protection system of claim 8, wherein said storage apparatus is disposed in an electronic apparatus.

14. The protection system of claim 8, wherein said storage apparatus is electrically connected to an electronic apparatus.

15. The protection system of claim 8, wherein said storage apparatus includes a storage apparatus main body and a read/write component, and said read/write component is for performing data read/write action to said storage apparatus main body.

16. The protection system of claim 15, wherein said storage apparatus main body includes at least one magnetic disk, and a magnetic core of said magnetic disk is used to store data.

17. The protection system of claim 15, wherein said read/write component performing data read/write action is to change positive and negative polarities of said magnetic core of said magnetic disk.

18. The protection system of claim 15, wherein said read/write component is at least one hard drive read/write head.
